(19) United States
(12) Patent Application Publication
(10) Pub. No.: US 2010/0116617 A1
(43) Pub. Date: May 13, 2010

(54) Isolator with one-way clutch

(76) Inventors: Alexander Serkh, Troy, MI (US); Imtiaz Ali, Lathrup Village, MI (US)

Correspondence Address: THE GATES CORPORATION, IP LAW DEPT. 10-A3, 1551 WEWATTA STREET, DENVER, CO, 80202, US

(21) Appl. No.: 12/291,797

(22) Filed: Nov. 13, 2008

(51) Int. Cl. F16D 41/04

(52) U.S. Cl. 192/41 S

(57) ABSTRACT

An isolator comprising a one-way clutch engaged with a hub structure, a belt engaging member, a resilient member operationally engaged between the one-way clutch and the belt engaging member, the belt engaging member engaged with the hub structure through a first and second ball bearing where by a radial load is transmitted through the first and second ball bearings, and the one-way clutch disposed between the first and second ball bearings such that no radial load is transmitted through the one-way clutch.

### FIELD OF THE INVENTION

The invention relates to an isolator with a one-way clutch, and more particularly to an isolator with one-way clutch having a resilient member operationally engaged between the one-way clutch and a belt engaging member.

### BACKGROUND OF THE INVENTION

Serpentine accessory drive systems are widely used on various vehicle engines including automotive, industrial, truck and bus. A typical serpentine drive system includes a driving pulley on the crankshaft of the vehicle engine. A belt is trained on a series of driven pulleys for the accessories. An advantage of the serpentine drive is that, by providing an automatic belt tensioner in the system, the accessories can be fixedly mounted instead of requiring a means of adjustment to properly tension the belt.

The engine crankshaft by its periodic pulse nature establishes a highly dynamic loading on the belt. This high dynamic loading is due to the variable torque output characteristics of internal combustion engines. The tensioner cannot accommodate all of the variable torque characteristics which causes fluctuations in the belt tension. The result can be noise and decreased belt life due to instantaneous belt slippage between the belt and the crankshaft pulley.

Engine crank shaft decouplers are used to deal with the high dynamic belt loading. Generally, the decoupler must have a capacity equal to the system capacity.

Representative of the art is U.S. Pat. No. 5,139,463 to Bytzek et al. which discloses a serpentine belt drive system for an automotive vehicle in which the sequence of driven assemblies includes an alternator assembly comprising a housing and an armature assembly mounted in the housing for rotation about an armature axis. A hub structure is carried by the armature assembly outwardly of the housing for rotation therewith about the armature axis. A coil spring is disposed in operative relation between the alternator pulley and the hub structure for transmitting the driven rotational movements of the alternator pulley by the serpentine belt to the hub structure such that the armature assembly is rotated in the same direction as the alternator pulley while being capable of instantaneous relative resilient rotational movements in opposite directions with respect to the alternator pulley during the driven rotational movement thereof.

What is needed is an isolator with one-way clutch having a resilient member operationally engaged between the one-way clutch and a belt engaging member. The present invention meets this need.

### SUMMARY OF THE INVENTION

The primary aspect of the invention is to provide an isolator with one-way clutch having a resilient member operationally engaged between the one-way clutch and a belt engaging member.

Other aspects of the invention will be pointed out or made obvious by the following description of the invention and the accompanying drawings.

The invention comprises an isolator comprising a one-way clutch engaged with a hub structure, a belt engaging member, a resilient member operationally engaged between the one-way clutch and the belt engaging member, the belt engaging member engaged with the hub structure through a first and second ball bearing where by a radial load is transmitted through the first and second ball bearings, and the one-way clutch disposed between the first and second ball bearings such that no radial load is transmitted through the one-way clutch.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is an exploded view of the preferred embodiment.

FIG. 2 is a perspective cross-sectional view of the embodiment in FIG. 1.

FIG. 3 is a cross-sectional view of the embodiment in FIG. 1.

FIG. 4 is a cross-sectional view of a one-way clutch.

FIG. 5(a) is a graph of the speed difference versus time between the alternator hub and the alternator pulley at low alternator load.

FIG. 5(b) is a graph of the speed of the alternator hub, alternator pulley and the crankshaft at low alternator load.

FIG. 5(c) is a graph of the alternator current at low alternator load.

FIG. 6(a) is a graph of the speed difference versus time between the alternator hub and the alternator pulley at high alternator load.

FIG. 6(b) is a graph of the speed of the alternator hub, alternator pulley and the crankshaft at high alternator load.

FIG. 6(c) is a graph of the alternator current at high alternator load.

FIG. 7(a) is a graph of the difference in oscillation of the alternator pulley and the alternator rotor with the alternator unloaded.

FIG. 7(b) is a graph of the difference in oscillation of the alternator pulley and the alternator rotor with the alternator loaded.

### DETAILED DESCRIPTION OF THE PREFERRED EMBODIMENT

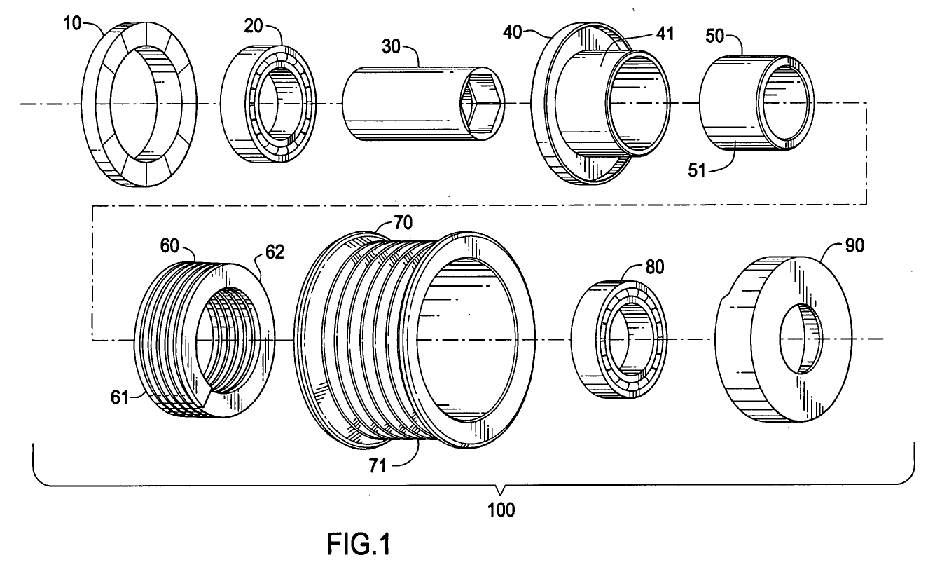

FIG. 1 is an exploded view of the preferred embodiment. The inventive isolator comprises a hub structure 30. A one-way clutch 50 is mounted to the hub structure 30. The hub structure may comprise a shaft for connection to an engine crankshaft (not shown) or driven accessory (not shown).

Inner carrier 40 is mounted to an outer surface 51 of one-way clutch 50.

Resilient member 60 has a first end 61 connected to the inner carrier 40. A second end 62 is connected to outer carrier 90. Resilient member 60 may comprise a torsional spring. The torsional spring may be the flat type having a substantially rectangular cross-section across each volute as shown.

The torsional stiffness of member 60 should be approximately 0.5-1.0 N-m/degree to provide a suitable safety factor for one-way clutch 50. Resilient member 60 engagement to the first and second end should be one directional, meaning the resilient member 60 is loaded in the unwinding direction. In other words when resilient member 60 is loaded its diameter increases. The expansion of resilient member 60 is limited by contact with the inner bore of belt engaging member 70. This ensures that the resilient member 60 is not overstressed and suffers fatigue failure. Since resilient member 60 is never operated in the winding direction because of the decoupling nature of the one way clutch, resilient member 60 does not contact the outer surface 41 of carrier 40.

End cap 10 is engaged with belt engaging member 70. Opposite end cap 10, outer carrier 90 is engaged with belt engaging member 70. End cap 10 and outer carrier 90 are rotationally engaged through bearing 20 and bearing 80, respectively. Each bearing 20 and 80 is engaged with hub structure 30.

One-way clutch 50 comprises those available in the industry, including but not limited to NTN HF type clutches, including part numbers HFO-612, 812, and HF1-012, 216, 416, 616, 816, and HF2-016, 520, and HF3-020, 520. These clutches have the desirable feature of having a thin radial thickness which in turn reduces the overall diameter and mass of the isolator.

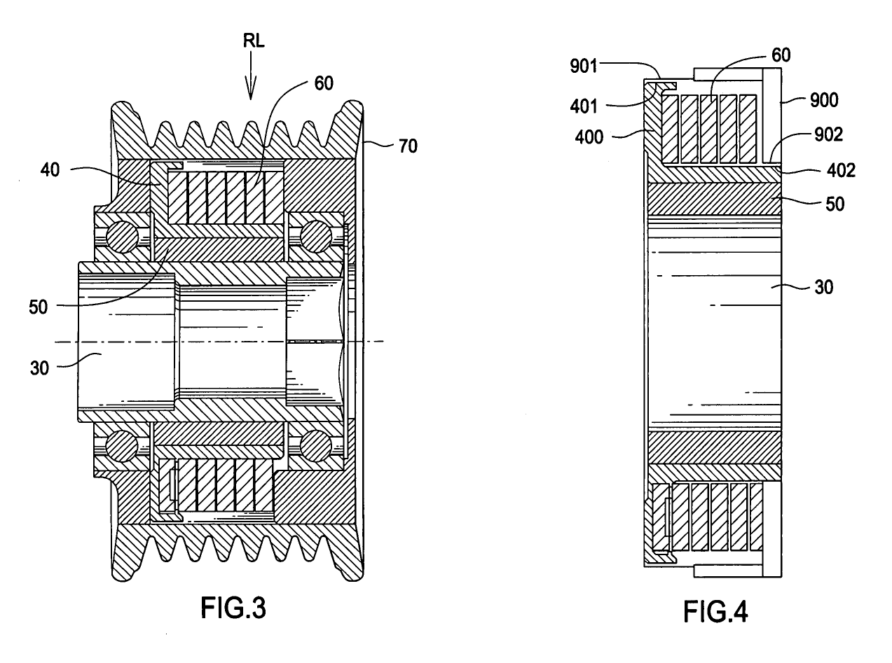

There are two requirements that are known related to one-way clutches outside the isolator arts. The first requirement is that the one-way clutch inner race should be supported concentrically with respect to the outer race. In other words a separate set of bearings should be used to accept any radial load present in the system which might otherwise deform the one-way clutch. For example, a radial load is imposed on the isolator due to a belt tensile load, see RL FIG. 3.

The most common location of the bearings is between input and output members, for example end cap 10 and outer carrier 90. The bearings are located in such a way that input and output members are concentric. This allows the one-way clutch installed between the input and output members to operate properly without a radial load being transmitted to the one-way clutch, in turn the inner and outer races will remain concentric as well. This arrangement is not taught in the isolator arts.

The second requirement is an excess of load carrying capacity that that is routinely designed into the one-way clutch. System applications with moderate to high torsional vibration (torque pulses) require a safety factor to be 15 to 20 for a one-way clutch to be suitably durable. The present design which incorporates a resilient member 60 reduces the safety factor which leads to a reduction in size, weight, and cost of the one-way clutch. The present isolator allows a one-way clutch safety factor in the range of approximately 5 to 10.

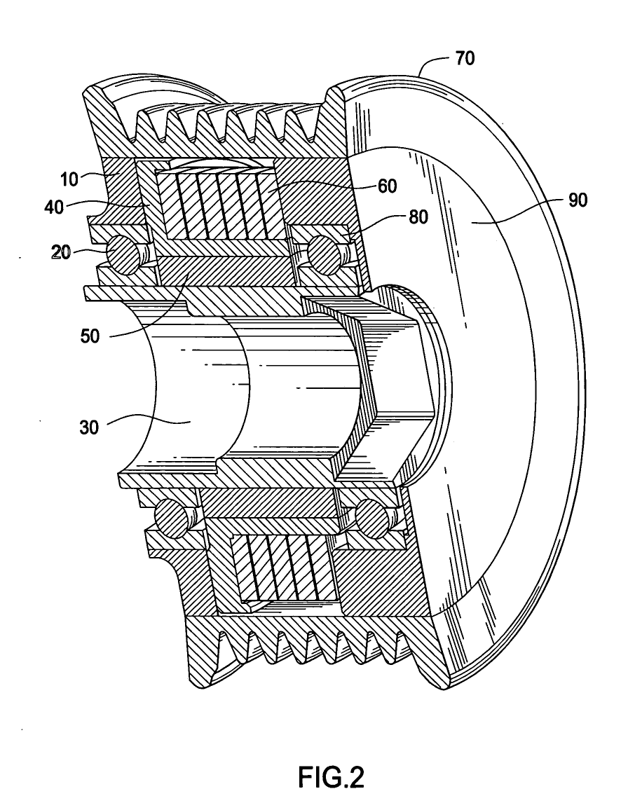

FIG. 2 is a perspective cross-sectional view of the embodiment in FIG. 1. One-way clutch is mounted to hub structure 30 between bearings 20 and 80. Inner carrier 40 is mounted to an outer surface 51 of one-way clutch 50. Surface 71 of belt engaging member 70 may have any suitable profile for engaging a belt, including multi-ribbed, single v-rib, or cogged. The multi-ribbed profile is shown.

End cap 10, inner carrier 40 and outer carrier 90 each seal the interior of the device, thereby protecting the one-way clutch from debris which could cause premature failure.

FIG. 3 is a cross-sectional view of the embodiment in FIG. 1. Belt engaging member 70 is freely rotatable about hub structure 30 through bearings 20 and 80. Of course, free rotation of belt engaging member 70 is subject to operation of one-way clutch 50 and resilient member 60. When locked one-way clutch 50 causes hub structure 30 to rotate in unison with belt engaging member 70 thereby allowing torque to be transmitted from belt engaging member 70 to hub structure 30, and thereby to an accessory (not shown) connected to hub structure 30.

Resilient member 60 resiliently controls rotational movement of belt engaging member 70 about hub structure 30 in a predetermined direction. In operation, torque pulses caused by cylinder firing of the IC engine are absorbed by the resilient member 60, which reduces or eliminates transmission of those pulses to the accessory attached to hub 30. In other words, an accessory (not shown) connected to the hub 30 is not forced to instantaneously follow the movements of the belt engaging member 70.

One-way clutch 50 provides an over-running feature. During engine deceleration belt engaging member 70 will proportionally decelerate because of the connection to a crankshaft pulley (not shown). However, the inertia of the accessories, for example an alternator, will tend to continue to rotate at its pre-deceleration speed (Newton's first law). The presence of the one-way clutch 50 will allow hub 30 to disengage and overrun the rest of the isolator structure since the isolator structure which will tend to rotate at the same speed as the decelerating crankshaft. The overrunning feature is vital since it eliminates the potential for belt slip and noise.

FIG. 4 is a cross-sectional view of a one-way clutch. One-way clutch 50 is mounted to a hub structure 30. Inner carrier 400 is mounted to an outer surface of one-way clutch 50. One-way clutch 50 comprises those available in the industry, including but not limited to NTN HF type clutches, including part numbers HFO-612, 812, and HF1-012, 216, 416, 616, 816, and HF2-016, 520, and HF3-020, 520. These clutches have the desirable feature of having a thin radial thickness.

Resilient member 60 is operationally engaged between inner carrier 400 and outer carrier 900. Resilient member may comprise a torsion spring, for example, comprising a round wire or flat wire.

A portion 901 of outer carrier 900 slidingly engages an outer surface 401 of inner carrier 400. A surface 902 engages a surface 402. The sliding engagement between the inner carrier and the outer carrier enables the over-ride feature during engine deceleration, for example. Before overrunning can occur, a minimal amount of torque must exist between the belt engaging member 70 and hub 30. Once the torque threshold is reached overrunning will occur. At this point the belt engaging member 70, outer carrier 90, resilient member 60 (displaced enough to cover the minimal torque) and inner carrier 40 rotate in unison as a single part at the same speed.

The one-way clutch described in FIG. 4 can be used in any suitable application, besides in an alternator isolator. The resilient member 60 attributes a soft landing feature to the device. Normally, lock up of the clutch can cause a shock to be transmitted through the system. This can in turn decrease the operational life of the system and its components. The resilient member soft landing feature affords protection to components that are operationally connected to the one-way clutch by significantly reducing the magnitude of shocks that might otherwise be transmitted.

The one-way clutch used in the isolator comprises one-way clutch 50, carrier 40, resilient member 60, and carrier 90.

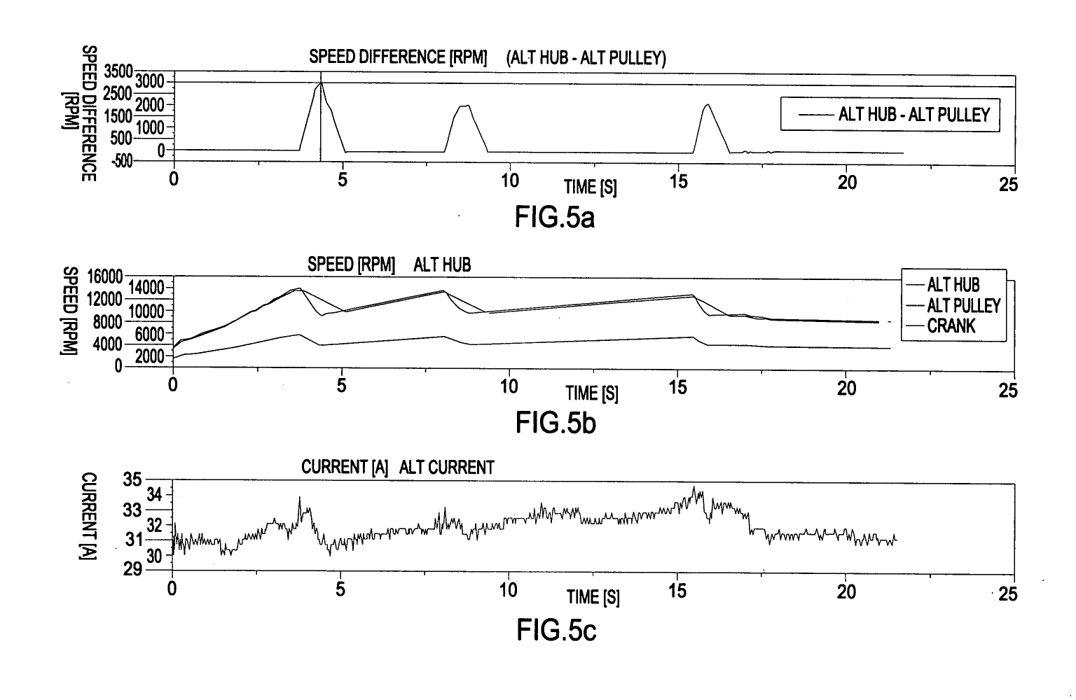

FIG. 5(a) is a graph of the speed difference versus time between the alternator hub and the alternator pulley at low alternator load. At low alternator loads the overrun speed is approximately 3000 RPM. The inventive one-way clutch is effective in decoupling alternator inertia during high engine decelerations and low alternator loads.

FIG. 5(b) is a graph of the speed of the alternator hub, alternator pulley and the crankshaft at low alternator load.

FIG. 5(c) is a graph of the alternator current at low alternator load.

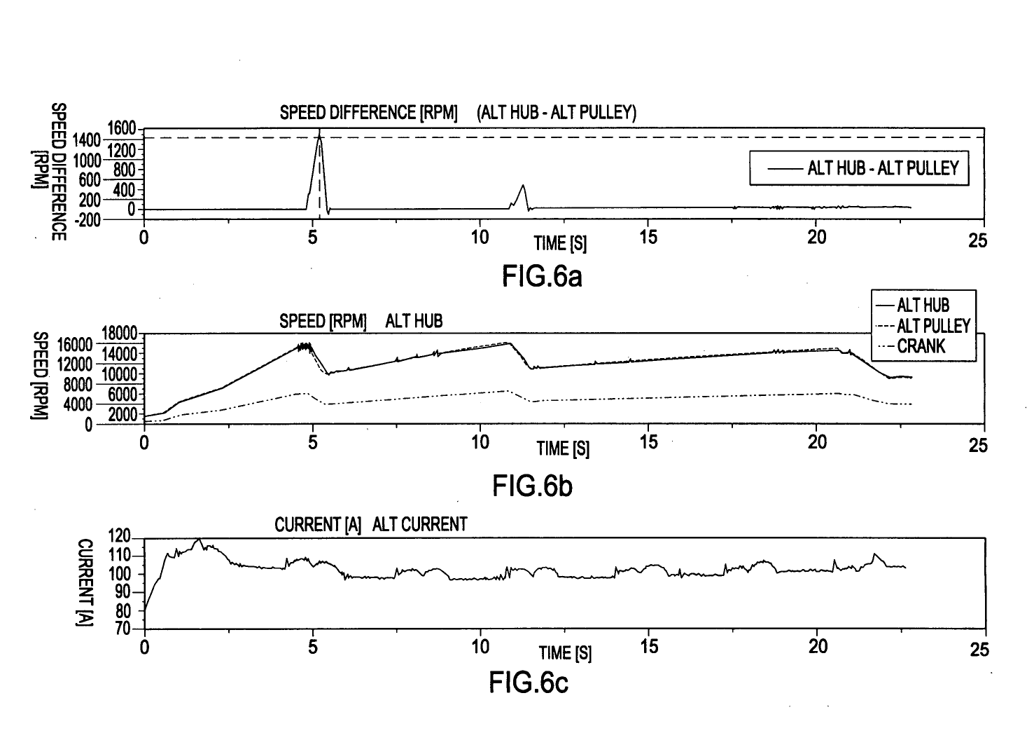

FIG. 6(a) is a graph of the speed difference versus time between the alternator hub and the alternator pulley at high alternator load. At high alternator loads the overrun speed is approximately 1400 RPM. The inventive one-way clutch is effective in decoupling alternator inertia during high engine decelerations and high alternator loads.

FIG. 6(b) is a graph of the speed of the alternator hub, alternator pulley and the crankshaft at high alternator load.

FIG. 6(c) is a graph of the alternator current at high alternator load.

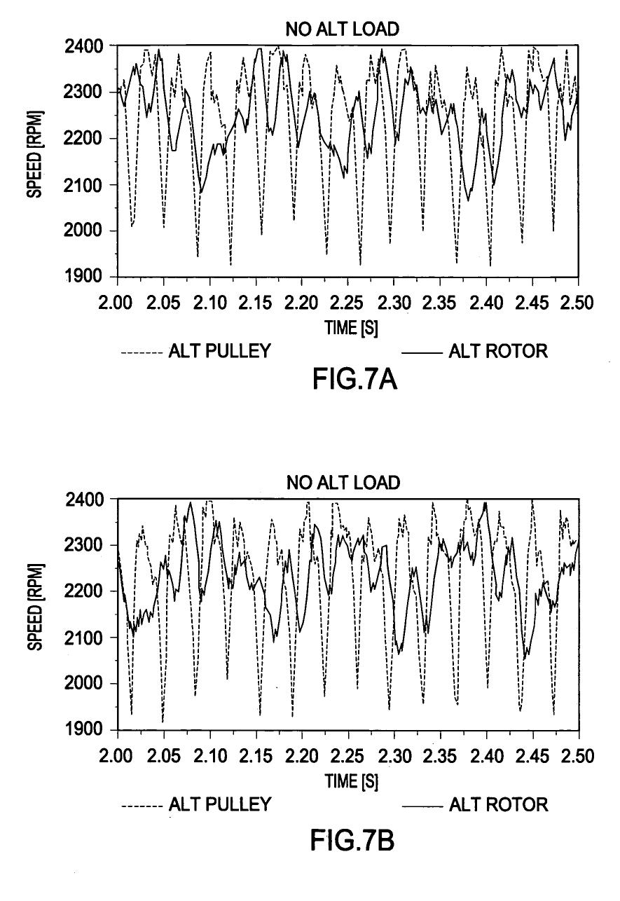

FIG. 7(a) is a graph of the difference in oscillation of the alternator pulley and the alternator rotor with the alternator unloaded.

FIG. 7(b) is a graph of the difference in oscillation of the alternator pulley and the alternator rotor with the alternator loaded. The inventive device is effective in reducing alternator rotor vibration compared to the alternator pulley vibration. Further, the plots demonstrate that the effectiveness and function of the isolator is not hindered by alternator load. This is a distinct advantage over prior art devices with only one-way clutches and no isolators, i.e., spring 60.

The information shown in FIGS. 5 and 6 was taken on the inventive device including the one-way clutch 50 while the data for the vibration attenuation shown in FIG. 7 was taken with an isolator only device without the one-way clutch 50. However, the behavior of the inventive device with a one-way clutch 50 is expected to be the same as shown in FIG. 7.

Although a form of the invention has been described herein, it will be obvious to those skilled in the art that variations may be made in the construction and relation of parts without departing from the spirit and scope of the invention described herein.

I claim:

1. An isolator comprising;
a one-way clutch engaged with a hub structure;
a belt engaging member;
a resilient member operationally engaged between the one-way clutch and the belt engaging member;
the belt engaging member engaged with the hub structure through a first and second ball bearing whereby a radial load is transmitted through the first and second ball bearings; and
the one-way clutch disposed between the first and second ball bearings such that no radial load is transmitted through the one-way clutch.

2. The isolator as in claim 1, wherein the resilient member comprises a torsion spring.

3. The isolator as in claim 1, wherein the belt engaging member comprises a multi-ribbed profile.

4. The isolator as in claim 1, wherein the hub structure comprises a shaft.
